(19) United States
(12) Patent Application Publication
(10) Pub. No.: US 2025/0189331 A1
(43) Pub. Date: Jun. 12, 2025

(54) A bidirectional interactive traffic-control management system with improved operational architecture through edge computation

(71) Applicant: THI Consultants Inc., Taipei (TW)

(72) Inventors: Chi-Hong Ho, Taipei (TW); Jun-Shian Lee, Taipei (TW); Tsung Yi Lee, Taipei (TW); Yi-Dar Lin, Taipei (TW); I-Ying Chen, Taipei (TW)

(21) Appl. No.: 19/057,580

(22) Filed: Feb. 19, 2025

Related U.S. Application Data
(63) Continuation-in-part of application No. 17/494,210, filed on Oct. 5, 2021, now Pat. No. 12,260,757.

(30) Foreign Application Priority Data
Oct. 5, 2020 (TW) 109134424

(51) Int. Cl. G01C 21/34

(52) U.S. Cl. CPC G01C 21/3492

(57) ABSTRACT

This invention provides a bidirectional interactive traffic-control management system with improved operational architecture through edge computation. The system comprises a server including a road and traffic network information subsystem, and an urban traffic control subsystem; and a plurality of terminal devices. For the purpose of edge computing, the plurality of terminal devices, located respectively at a road user end or a roadway end, is independently provided from a central server. The urban traffic control subsystem further includes an intersection grouping module for grouping adjacent intersections according to a correlation nature of their approach arrival-flow patterns, wherein the intersections in the digital urban traffic-control road network are divided into signal groups including isolated intersection groups, arterial intersection groups, and network intersection groups according to the correlation nature of their approach arrival-flow patterns, either high or low, between adjacent intersections in the urban traffic control network.

### CROSS-REFERENCE TO RELATED DOCUMENTS

The present invention is a continuation in part (CIP) to a U.S. patent application Ser. No. 17/494,210 entitled “A BIDIRECTIONAL INTERACTIVE TRAFFIC-CONTROL MANAGEMENT SYSTEM” filed on Oct. 5, 2021.

### FIELD OF THE INVENTION

The present invention is related to a brand new urban traffic-signal control system with improved operational architecture through edge computation, especially a bidirectional interactive traffic-control management system with improved operational architecture through edge computation including an independent route guidance function from terminal devices for road-users.

### BACKGROUND OF THE INVENTION

For any modern city, in order to effectively manage its road traffic to improve the operation efficiency of the road network and to ensure the traffic safety of road-users, a computerized traffic signal control system (hereinafter referred to as urban traffic control system) covering the whole urban road network will always be built.

Current urban traffic control systems are usually composed of a traffic control/management center provided with a main control computer, a timing-plan generation computer, some peripheral devices, and an electronic traffic control map display, and various vehicle detectors installed in some road sections or at some intersections, as well as traffic signal controllers, signal heads, and signal poles installed at intersections, connected with a data communication system.

Normally the generation of the real-time signal timing plan for each intersection in the road network is done by transmitting traffic flow information of each road section and/or of each intersection in the road network through various vehicle detectors located in some road sections or at some intersections and then by aggregating and computing those traffic flow information through the timing plan generation computer located in the traffic control center or regional traffic control sub-centers. Then, the real-time signal timing plan is transmitted to the traffic signal controller located at each intersection via the data communication system, so as to drive the traffic lights into operation and then to control the traffic flow at each intersection.

However, for most of the urban traffic control systems, conventionally, vehicle detectors must be installed at least on some road sections or at some intersections in order to obtain the real-time traffic flow information of the road network, and these vehicle detectors to be installed are not only numerous and costly, but also the cost of their daily operation, adjustment and maintenance is very expensive, thus resulting in a heavy financial burden inevitably.

In addition, road-users often use a so-called navigator/navigation module or route guidance APP imbedded in their mobile devices, e.g. mobile phones, etc., or in on-board-units of their vehicles as their travel route planning tools to reach their trip destinations. However, current route planning tools can only provide the road-users with general or rough but not precise route suggestions, because those planning tools can only perform relatively simple route calculation without including any signal timing information therein and thus usually are not capable of providing the real best/optimal travel routes, and varying degrees of errors which would occur in the calculation process of the optimal travel routes that are difficult to overcome. For example, those route planning tools may possibly navigate the vehicles of lots of road-users to one specific arterial road, which may cause or worsen the traffic congestion of that arterial road.

In addition, if the real-time optimal signal timing calculation of all intersections in the entire urban traffic control network and the real-time optimal traveling route calculation of all road users in the entire urban traffic control network are performed on the main control computer or a cloud server only, its computing load will be too heavy to meet the real-time requirements of long-term system operations. In addition, considering that the scope of the entire urban traffic control network is likely to expand year by year, for example, if it covers more than tens of thousands of signalized intersections, the computer calculation operation for this working structure would inevitably consume excessive computing power and take a lot of time, and thus it is unable to meet the system functional requirement of producing the optimal signal timing for each intersection in real time.

On the other hand, considering that some road-users on the urban traffic control network may have a particularly long traveling distance, for example, tens to hundreds of kilometers, etc., If the central server need to generate the best traveling route, by passing through hundreds or thousands intersections along the way, for each road-user in the calculation operation, it would consume too much of the limited computing resources and time in the central server, making it impossible to produce the optimal traveling route for each road-user in real time in order to meet systematic functional requirements.

Therefore, how to provide a bidirectional interactive traffic-control management system with both functions of real-time optimal signal timing plan generation and real-time optimal route guidance generation is definitely an important issue to be solved. Accordingly, the present invention has developed a new real-time integrated and interactive system which may avoid the above-described drawbacks, may significantly enhance the performance of both existing traffic control systems and existing vehicle navigation/route guidance systems which are now operated separately, and may take into account economic efficiency as a whole. Therefore, the present invention then has been developed and presented.

### SUMMARY OF THE INVENTION

In order to overcome the above technical problems, the present invention sets the first and second subsystems, i.e., the traffic network information subsystem and the urban traffic control subsystem, in the central server or the big data center of the urban traffic control center in the cloud server of the data center, the third subsystem, i.e., the road-users' route guidance subsystem, is downloaded or implanted into terminal devices at the road-user end or the roadway end to perform interactive computing operations. The intersection grouping module in the urban traffic control subsystem divides the entire urban traffic control network into multiple intersection groups. The road-users' route guidance subsystem further includes a travel route segmentation module, which divides the entire alternative traveling route of each road-user into multiple intersection groups. The entire route of each alternative driving route is first divided into a number of segments according to the traveling distance or traveling time of each road-user within the optimal route updating cycle. And the road-users' route guidance subsystem will only perform a precise travel time calculation, by adding actual delay time in passing the subsequent intersections to the travel time in passing subsequent road sections, for the first partition of each alternative traveling route. Then the optimal traveling route of each road-user can be generated, by combining and sorting total travel time of both partitions, among all alternative traveling routes.

According to the embodiment of the present invention, the present invention provides a bidirectional interactive traffic-control management system with improved operational architecture through edge computation comprising: a server, including: a road and traffic network information subsystem, including a digital urban traffic-control road network and a road-users' travel information input module; an urban traffic control subsystem, being coupled with the road and traffic network information subsystem; and a plurality of terminal devices located respectively at a road-user end or a roadway end, and are independently provided from a central server, where each terminal device is coupled with the road and traffic network information subsystem and the urban traffic control subsystem, and the plurality of terminal devices is configured to collect the road-users' real time travel information, and each terminal device includes a road-users' route guidance subsystem; wherein the server is configured to executed following steps: the digital urban traffic-control road network stores a vector-type road structure including a plurality of road sections and a plurality of intersections including various road geometric characteristics and traffic control attributes that are pre-stored; the road-users' travel information input module receives the road-users' real time travel information from the plurality of terminal devices to collect real-time travel information of road-users on the plurality of road sections; the collected road-users' travel information is overlaid with the road geometric characteristics and traffic control attributes that are pre-stored to form real-time integrated traffic information in the plurality of road sections and plurality of intersections of the digital urban traffic-control road network; an urban traffic control subsystem generates a real-time optimal signal timing plan for each intersection according to the real-time integrated traffic information of all road sections which are linked together by intersections; and a road-users' route guidance subsystem generates a real-time optimal route plan for each road user who has provided real time travel information to each terminal device for navigating each road user corresponding to a terminal device to the optimal subsequent travel route by calculating the real-time travel information of all road-users, the real-time integrated traffic information of each road section, and the real-time optimal signal timing plan of each intersection; wherein the urban traffic control subsystem further includes an intersection grouping module for grouping adjacent intersections according to a correlation nature of their approach arrival-flow patterns, wherein the intersections in the digital urban traffic-control road network are divided into signal groups including isolated intersection groups, arterial intersection groups, and network intersection groups according to the correlation nature of their approach arrival-flow patterns, from high to low, between adjacent intersections in the urban traffic control network; wherein the urban traffic control subsystem further includes a timing plans generation module for generating multiple feasible signal timing plans for each intersection in the digital urban traffic-control road network according to the time-space arrival-flows matrix or pattern of each intersection and signal timing restrictions of each intersection; wherein the urban traffic control subsystem further includes a timing plans optimization module for generating the real-time optimal signal timing plan by optimizing an objective function of the multiple feasible signal timing plans according to a set of pre-determined traffic control objective; wherein the real-time optimal signal timing plan is updated according to the combinations of trip destination point and one of beginning location and subsequent instant location of each road-user.

In one embodiment, the urban traffic control subsystem is further for generating optimal signal timing plans corresponding to each isolated intersection groups, each arterial intersection groups, and each network intersection groups; wherein the optimal signal timing plan of each intersection in the same signal group has the same signal cycle-length and separate green time split and specific signal offset, so as to maintain a fixed timing plan relationship among all the intersections in the same signal group.

In one embodiment, if the road-users' route guidance subsystem is provided in a mobile device or an on-board unit of a road user, the real-time optimal route plan is generated for the road user to use in the mobile device or on-board unit corresponding to each road user; if the road-users' route guidance subsystem is provided in the roadside units or if a system of a third-party travel information service provider is used, then input frequencies of the road-user's traveling information, operation frequencies of the timing plans optimization module and/or necessity evaluations of route update are firstly evaluated, and then the generated real-time optimal route plan is transmitted to the mobile device or the on-board unit corresponding to each road user.

In one embodiment, further including a system of a third party travel information provider, connected with the server and many terminal devices, for receiving the real-time traveling information of some road-users collected by their mobile devices or on-board units and transmitting it to the road and traffic network information subsystem; the system of the third party travel information provider is also used for transmitting the real-time optimal route plans to some mobile devices or on-board units corresponding to the road-users.

In one embodiment, the road-users' route guidance subsystem further includes a travel route segmentation module, be configured to perform the following steps: all feasible alternative traveling routes for each road user is generated by calculating the real-time travel information of each road-user, real-time integrated traffic information of each road section, and real-time optimal signal timing plan of each intersection in the road and traffic network information subsystem, then and an optimal traveling route calculation operation is first performed on the sections with the higher ranking, and then an optimal traveling route calculation operation for the remaining sections is performed in sequence, and the real-time optimal route planning for each user who provides route information is generated and sent it to each terminal device in sequence, so as to guide each road user corresponding to each terminal device to obtain the real-time optimal route plan.

In one embodiment, the urban traffic control subsystem further comprises an intersection arrival-flow prediction module, be configured to perform the following steps: all vehicles traveling on each upstream adjacent road segment of each intersection are considered based on real-time traffic information from road sections within the urban traffic control network; the travel time required for each vehicle to reach its downstream intersection is estimated by dividing the distance between the vehicle's current location and the downstream intersection by the average speed of the corresponding upstream road section; subsequently, the traffic flow arrival rate distribution of all turning movements at each approach of the intersections within the urban traffic control network is calculated in real-time based on an update time interval set by the intersection arrival-flow prediction module for generating the real-time optimal signal timing plan of each intersection.

In one embodiment, the timing plan generation module is configured to perform the following steps: based on the traffic flow constraints of each intersection, dividing the turning flow rate of each signal phase of each intersection by the saturation flow rate of the corresponding turning movement, thereby the flow ratio of that turning movement is obtained; then, the largest value of the flow rate among all turning movements in each signal phase is selected as the representative flow rate of that signal phase in the entire signal cycle of each intersection; the representative flow rate of all signal phases are compared with each other to form the green time split ratio of the entire signal cycle of each intersection, and the actual green time of each phase within the entire signal cycle can be allocated according to the green time split ratio.

In one embodiment, the timing plans generating module is further used to perform the following function: based on the green time split ratio of each phase in a signal cycle of each intersection, both an upper and a lower limits of all feasible signal cycle lengths, traffic signal regulation conditions and traffic flow restriction conditions preset at each intersection; multiple feasible signal timing plan alternatives for each intersection are then obtained.

In one embodiment, the road-users' route guidance subsystem further includes a route guidance optimization module for calculating the value of a target performance index among the multiple feasible route plans, one by one, based on a pre-determined route planning objective, and extracts one traveling route plan with the optimal or best value of the target performance index as the real-time optimal route plan for each road-user from his/her current location to the predetermined destination point.

In one embodiment, the alternate routes generation module is configured to generate the multiple feasible route plans within the urban traffic control network by performing the following steps: calculating, for each vehicle from its current location to its destination point, the travel time or travel distance required to reach its first downstream intersection, the total travel time or total travel distance required to traverse all complete road segments along the subsequent route, and the average delay time at each signalized intersection or the travel distance within each intersection; combining these travel times or distances for all feasible route plans to form a first combination group; and applying several multiple-path network analysis methods on the first combination group.

In one embodiment, the road-users' route guidance subsystem further includes an alternate routes generation module, which is configured to generate K shortest travel routes for each road user within the urban traffic control network by performing the following steps: searching all feasible routes from each road user's current location to predetermine a destination point by applying multiple-path network analysis methods; estimating total travel time of each route by adding travel time spent in each road section plus average stopped delay due to red signal time at each intersection along the route; defining a limited number (K) of feasible travel routes for more accurate travel time computation, so as to reduce computing power and facilitate real-time update, and sorting all feasible routes according to total travel time to choose K shortest travel routes

In one embodiment, the road-users' route guidance subsystem further includes a travel route segmentation module, which is configured to generate a more accurate travel time of the first road segment of K shortest travel routes by performing following steps: partitioning each travel route into two segments for all K shortest travel routes by travel time or equivalent travel distance based on the update frequency of optimal travel route or the real-time update requirement; predicting the arrival time when the road-user reaches each downstream intersection within one first segment of each travel route based on the instantaneous driving speed of each road section along the first segment of each travel route; calculating stop-and-wait delays caused by red signal time at each intersection along the first segment of each travel route by comparing predicted arrival time and an optimal signal timing currently in effect at each intersection; obtaining a more accurate travel time of the first segment of each travel route by adding all driving time of each road section and all stop-and-wait delays at each intersection along the first segment of each route.

In one embodiment, the road-users' route guidance subsystem further includes a route guidance optimization module, be configured to generate the optimal driving route for each road user, by performing the following steps: recalculating a more accurate total travel time of K shortest routes by adding the more accurate travel time of the first segment of each route and previously estimated travel time of the second segment of each travel route; sorting the more accurate total travel time for all K shortest travel routes; optimizing an objective function for K shortest travel routes according to pre-determined route planning objectives which are of the minimum total travel time, or the minimum total travel distance, and/or a route choice preference setting; choosing the travel route with minimum total travel time or the best value of the objective function as the optimal travel route for each road user.

### BRIEF DESCRIPTION OF DRAWINGS

FIG. 1 is a block diagram showing the framework of the bidirectional interactive traffic-control management system with improved operational architecture through edge computation of the present invention, compared with the original system frame without improvement;

FIG. 2 is a schematic diagram showing all uploading data transmission services of road-users' real-time travel information according to an embodiment of the present invention;

FIG. 3 is a detail schematic diagram showing the entire interactive operation and data flow procedure among all the working modules included in the three subsystems of the bidirectional interactive traffic-control management system with improved operational architecture through edge computation according to another embodiment of the present invention; and

FIG. 4 is a schematic diagram showing an example of the detail route partition configuration among all feasible route alternatives from current location to the destination of each road-user performed by the travel route segmentation module of the present invention.

### DETAILED DESCRIPTIONS OF PREFERRED EMBODIMENTS

For the sake of clarity and convenience to illustrate the figures of the present invention, the components in the figures may be enlarged or reduced in size and scale. For ease of understanding, the same components in the following examples are illustrated by the same numeric reference.

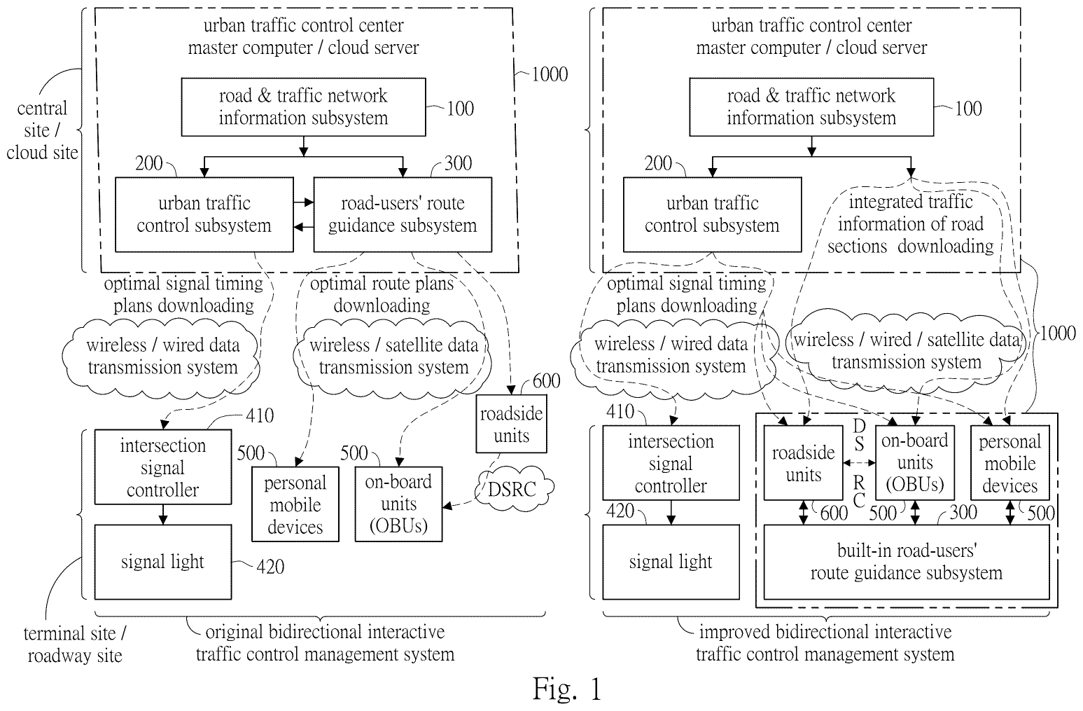

Please refer to FIG. 1; it is a block diagram of a bidirectional interactive traffic-control management system with improved operational architecture through edge computation 1000 of the present invention. The bidirectional interactive traffic-control management system with improved operational architecture through edge computation 1000 provided in a server includes a road and traffic network information subsystem 100, and an urban traffic control subsystem 200.

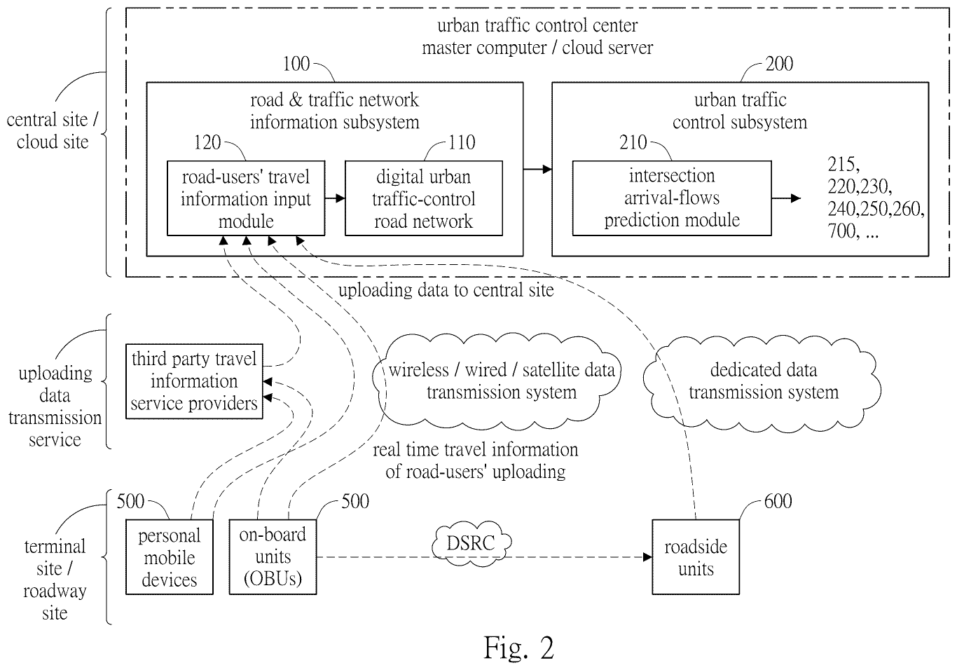

Please refer to FIG. 2, the road and traffic network information subsystem 100 includes a digital urban traffic-control road network 110 and a road-users' travel information input module 120. The digital urban traffic-control road network 110 is a vector-type structure composed of a plurality of road sections and a plurality of intersections featuring various road geometric characteristics and traffic control attributes.

Refer to FIG. 1, a plurality of terminal devices (500, 600) located respectively at a road user end or a roadway end, and are independently provided from the server, where each terminal device is coupled with the road and traffic network information subsystem 100 and the urban traffic control subsystem 200, and the plurality of terminal devices 500 and roadside units 600 are configured to collect the road-users' travel information, and each terminal device 500 and 600 includes a road-users' route guidance subsystem 300.

The server is configured to executed following steps: the digital urban traffic-control road network 110 stores a vector-type road structure including a plurality of road sections and a plurality of intersections including various road geometric characteristics and traffic control attributes that are pre-stored; the road-users' travel information input module 120 receives the road-users' travel information from the plurality of terminal devices 500 and 600 to collect real-time travel information of road-users on the plurality of road sections; the collected road-users' travel information is overlaid with the road geometric characteristics and traffic control attributes that are pre-stored to form real-time integrated traffic information in the plurality of road sections and plurality of intersections of the digital urban traffic-control road network; the urban traffic control subsystem 200 generates a real-time optimal signal timing plan of each intersection according to the real-time integrated traffic information of all road sections which are linked together by intersections; and a road-users' route guidance subsystem 300 generates a real-time optimal route plan of each road user, who has provided travel information, to each terminal device 500 through edge computing, in the terminal device 500 corresponding to each road user or in the roadside units 600, for navigating each road-user corresponding to each terminal device to the optimal subsequent travel route by calculating the real-time travel information of all road-users, the real-time integrated traffic information of each road section, and the real-time optimal signal timing plan of each intersection.

Moreover, in some embodiment, the road-users' travel information input module 120 is coupled with the digital urban traffic-control road network 110. The road-users' travel information input module 120 collects real-time travel information of road-users from the terminal devices (500 or 600) on each road section of the digital urban traffic-control road network 110, and to overlay it into the digital urban traffic-control road network 110 in order to form a real-time integrated traffic information of each road section of the digital urban traffic-control road network 110. The real-time travel information of road-users includes information of trip origin and destination points of road-users and the instant location information of road-users driving on each road section of the digital urban traffic-control road network.

In another embodiment of the present invention, the real-time travel information of road-users may include information about traffic accidents, traffic incidents or traffic congestion events, road construction and/or weather information, and/or driving track information, and/or route choice preference information (e.g. avoiding toll roads, avoiding downtown areas, avoiding signalized intersections, prioritizing arterials). In addition, said travel information of road-users may be provided to the road-users' travel information input module 120 by the road-users' mobile device 500 (e.g. a navigator/navigation module which is imbedded in the road-user's mobile phone, intelligent watch or intelligent eyeglasses, an on-board-unit of a moving vehicle, etc.) and/or via a roadside unit 600. In one embodiment, road-users can use various data transmission services, such as mobile data communication network of the mobile device 500 or Wi-Fi/Wi-max network or satellite communication network, to transmit road-users' travel information into road-users' travel information input module 120, or via a roadside unit 600 to forward it to the road-users' travel information input module 120. In this way, a variety of data transmission paths can be provided for transmitting, as complete and as real-time as possible, the road-users' real-time traveling information, such as traffic accidents or incidents, traffic congestion, road construction information and/or weather information.

In another embodiment of the present invention, as described above, the real-time traveling information of each road user required by the traffic network information subsystem 100 of the present invention is uploaded directly to the server from the mobile device 500 of the road user, or indirectly uploaded to the server via the roadside equipment 600.

In another embodiment, refer to FIG. 2, the system of the present invention further includes equipment of third party travel information service providers, such as indirect information uploading equipment of vehicle service stations, etc. The equipment of the third party travel information service provider first collects the real-time traveling information from the road user, and then uploads or forwards it to the road and traffic network information subsystem 100 for subsequent data processing operations.

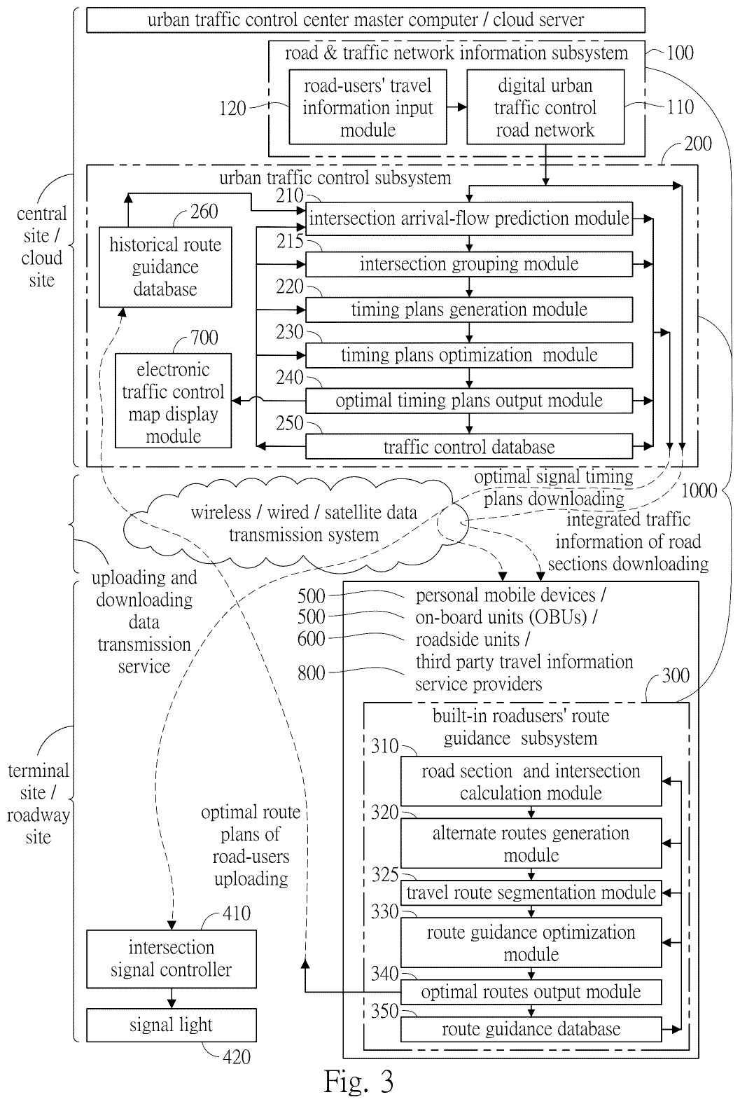

Refer to FIG. 2 and FIG. 3, the uploaded real-time traveling information of each road user, the downloaded real-time optimal signal timing plan of each intersection, and the real-time optimal driving route of each road user are uploaded to the server or downloaded to the roadway end or the road user end through various current communication networks. Those various communication networks include: various wireless, wired, satellite communications, Low-Earth Orbit communications, dedicated short-range communications (DSRC) and other data communication methods, all of which are within the scope of the present invention.

In one embodiment, refer to FIG. 2, the system of the present invention further includes a system of a third party travel information provider, connected with the server and the terminal devices, for receiving the real-time traveling information of some road-users collected by their mobile devices 500 or on-board units 500, and transmitting it to the road and traffic network information subsystem 100. The system of the third party travel information provider is also used for transmitting the real-time optimal route plan to a mobile device 500 or an on-board unit 500 corresponding to some road-users.

In one embodiment, if the road-users' route guidance subsystem 300 is provided in a mobile device or an on-board unit of a road user, the real-time optimal route plan is generated for the road user to use in the mobile device 500 or on-board unit 500 corresponding to the road user. In another embodiment, refer to FIG. 3, if the road-users' route guidance subsystem 300 is provided in the roadside units 600 or if a system of a third-party travel information service provider is used, then input frequencies of the road user's traveling information, operation frequencies of the timing plans optimization module 230 and/or necessity evaluations of route update are firstly evaluated, and then the generated real-time optimal route plan is transmitted to the mobile device 500 or the on-board unit 500′ corresponding to each road user.

In certain embodiments, when the urban traffic control subsystem 200 generates the optimal real-time signal timing plan for each intersection, and when the road-users' route guidance subsystem 300 generates the optimal real-time travel route for each road user, the required interactive data transmission operations are all performed in the main control computer provided into the urban traffic control center or the server (cloud) of the big data center.

Please refer to FIG. 3, in certain embodiments, an interactive information transmission architecture is provided for downloading from the server and uploading from the terminal devices 500, 600. The information items downloaded from the central end include: real-time traffic information of each road section in the digital urban traffic control network 110 downloaded from the traffic network information subsystem 100 of the central end to the road user's route guidance subsystem 300 at the road user end; secondly, the real-time optimal signal timing plan of each intersection is downloaded from the optimal timing plans output module 240 of the urban traffic control subsystem 200 to the corresponding intersection traffic control facilities 410 and the road-users' route guidance subsystem 300. On the other hand, the information items that need to be uploaded include: real-time traveling information of road-users' directly uploaded from the mobile devices of each road user, or via the adjacent roadside equipment, or via the system of a third-party traffic information value-added service provider, to the road-users' travel information input module 120 in the road and traffic network information subsystem 100 at the central end; the optimal routes output module 340 in the road-users' route guidance subsystem 300 of the road user provides the real-time optimal travel route of each road user for the road-user's own reference, and is also directly or indirectly uploaded to the historical route guidance database 260 at the central end for the use of the urban traffic control subsystem 200, so as to generate the real-time optimal signal timing plan for each intersection in the next stage.

In certain embodiments of the present invention, the road-users' route guidance subsystem 300 is used, by edge computing, to generate the optimal traveling route for each road user in real time. Considering that the number of road-users traveling in the entire urban traffic control road network 110 may be extremely large, for example, up to thousands to tens of thousands of road user as mentioned above, if all the calculation operations are concentrated in the server at the central end, it would consume too much computing power and time, and may not meet the system function requirement of generating the optimal traveling routes for all road-users in real time. Therefore, please refer to FIG. 3. This embodiment downloads or embeds the road-users' route guidance subsystem 300 into the road user side or the roadway side or the equipment of the third-party travel information value-added service provider, so as to separately and independently produce the real-time optimal traveling route plan for each road user from the server, so as to significantly reduce the computing power and time loading originally required to process large amount of road-users at the same time, and achieve the technical effect of the system functional requirement of producing the optimal traveling route for each road user in real time.

The road-users' route guidance subsystem 300 is respectively coupled to the road and traffic network information subsystem 100 and the urban traffic control subsystem 200. The road-users' route guidance subsystem 300 includes a road section and intersection calculation module 310, an alternative routes generation module 320, a travel route segmentation module 325, a route guidance optimization module 330, an optimal routes output module 340, and a route guidance database 350.

The road-users' route guidance subsystem 300 obtains optimal real-time route plans according to the real-time travel information of road-users, the real-time integrated traffic information of plurality of road sections, and the real-time optimal signal timing plan of each intersection generated by the urban traffic control subsystem 200, directly from the mobile device 500 of each road user or indirectly from the roadside units 600 and then forwards the real-time optimal route plan to nearby corresponding road-users.

The road section and intersection calculation module 310 obtains the real-time average vehicle speed of each road section, the estimated arrival time at each intersection, the travel time in each road section, and the average delay time at each intersection according to the real-time integrated traffic information of each road section, the length of each road section, and the real-time optimal signal timing plan of each intersection generated by the urban traffic control subsystem 200.

The alternative routes generation module 320 is coupled to the road section and intersection calculation module 310. The alternative routes generation module 320 generates multiple feasible driving route plans by calculating the real-time integrated traffic information of each road section, the real-time average vehicle speed of each road section, the estimated arrival time at each intersection, the travel time in each road section, and the delay time at each intersection.

For example, the alternative routes generation module 320 can set the instant location point from the driving trajectory provided by a road user (i.e. his/her current position) as a starting point (i.e. new trip origin point) of his/her subsequent route. Then on the digital urban traffic-control road network 110, a mathematical programming method of network planning is used to generate multiple feasible alternative routes from the new starting point of the subsequent route of the road user to his/her trip destination point.

Next, the alternative routes generation module 320 will add up the multiple feasible alternative routes, the travel time passing through each road section, and the average delay time when crossing each intersection on the subsequent route (according to the optimal timing plan implemented at each intersection), to obtain a predicted value of the total travel time of each subsequent feasible alternative route for the road-user. Accordingly the multiple feasible driving routes described above are obtained.

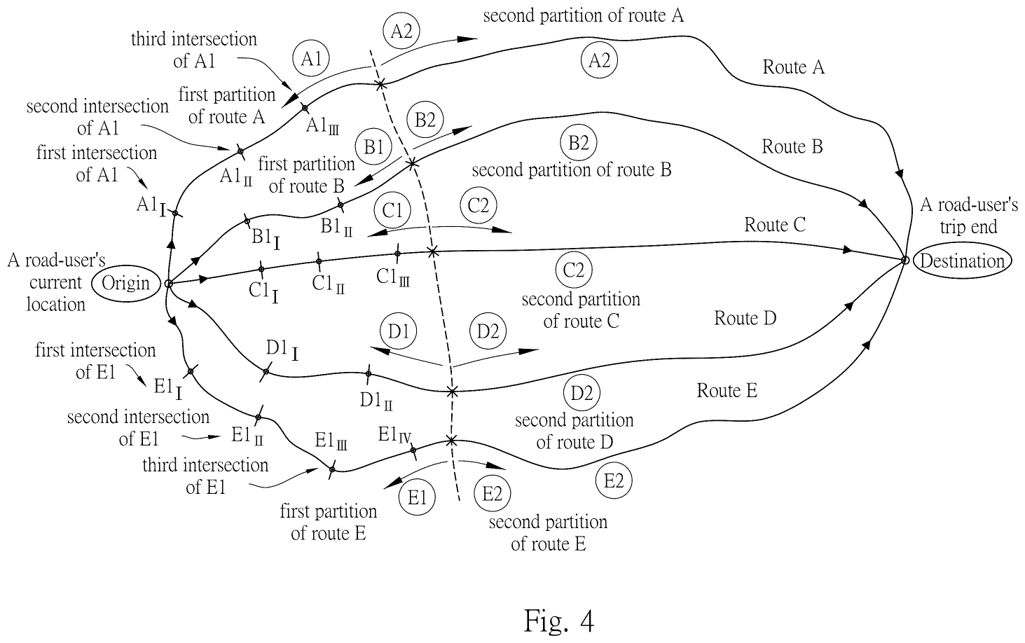

Refer to FIG. 4, the alternative routes generation module 320 is coupled to the road section and intersection calculation module 310. The alternative routes generation module 320 generates K shortest travel routes for each road user within the urban traffic control network by calculating the real-time integrated traffic information of each road section, the length and real-time average vehicle speed of each road section, the estimated arrival time at each intersection, the travel time in each road section, and the average stopped delay time at each intersection.

The alternative routes generation module 320 can set the instant location point from the vehicle trajectory provided by a road user (i.e. his/her current position) as a starting point (i.e. new trip origin point) of his/her subsequent route. Then on the digital urban traffic-control road network 110, an existing mathematical programming method of network planning can be used, at first, to generate multiple feasible alternative routes from the new starting point of the subsequent route of the road user to his/her trip destination point.

Next, the alternative routes generation module 320 will create K shortest travel route for each road user within the urban traffic control network by defining a limited number (K) of feasible travel routes for further more accurate travel time computation. This helps reduce computing power and facilitate real-time optimal route update. Then total travel time for all feasible routes is sorted in order and K shortest routes are shortlisted accordingly.

Refer to FIG. 4, in another embodiment, the road-users' route guidance subsystem 300 further includes a travel route segmentation module 325 to generate a more accurate travel time of the first road segment of K shortest routes, by applying a “dynamic/time-dependent progressive computation method”. In accordance with the update frequency of optimal route or real-time optimal route update requirement, all K shortest routes are partitioned into two segments, e.g. first partition of route A (A1) and second partition of route A (A2) . . . etc., by travel time or equivalent travel distance. Then based on instantaneous driving speed of each road section along the first segment, the arrival time is predicted as the road-user reaches each downstream intersection within the first segment. The stop-and-wait/stopped delays caused by traffic signal at each intersection along the first segment of each route are calculated by comparing the predicted arrival time and the optimal signal timing currently in effect at each intersection. Since the previously estimated travel time (in alternate routes generation module 320) only uses an average stopped delays at each intersection along the travel route, a more accurate travel time of the first segment of each route can be obtained subsequently by adding all driving time of each road section and all stop-and-wait/stopped delays of each intersection of the first segment of each route.

Refer to FIG. 4; the route guidance optimization module 330 is coupled to the travel route segmentation module 325. The route guidance optimization module 330 generates the real-time optimal travel route by optimizing an objective function according to a pre-determined route planning objective or simply minimizing total travel time among the K shortest travel routes. The pre-determined route planning objective may be the minimum total travel time or the minimum total travel distance, and/or a route choice preference setting. A more accurate total travel time of K shortest travel routes can be calculated by adding the more accurate travel time of the first segment and previously estimated travel time of the second segment of each travel route. Total travel time for all K shortest travel routes is thus sorted into order again. An objective function for K shortest travel routes can be optimized according to pre-determined route planning objectives which are the minimum total travel time, or the minimum total travel distance, and/or a route choice preference setting. The route with minimum total travel time or the best value of the objective function is selected as the optimal travel route for each road user.

The route guidance optimization module 330 is coupled to the alternative routes generation module 320 and the travel route segmentation module 325. The route guidance optimization module 330 generates the real-time optimal route plan by optimizing an objective function among the multiple feasible route plans according to a pre-determined route planning objective. The pre-determined route planning objective may be the minimum total travel time or the minimum total travel distance, and/or a route choice preference setting. In practice, the calculation method of the route guidance optimization module 330 can be implemented by using various searching methods, such as exhaustive search method or other mathematical methods.

The optimal routes output module 340 is coupled to the route guidance optimization module 330 and the historical route guidance database 260 in the urban traffic control subsystem 200. The optimal routes output module 340 stores the results of the real-time optimal route plan in the mobile devices 500 of the road-users and transmits, or via the roadside units 600, to the urban traffic control subsystem 200 in real-time based on the input frequency of the real-time travel information of road-users, the calculation frequency of the route guidance optimization module 330 and/or the necessity evaluation.

It should be noted that the necessity evaluation is to calculate the difference between the real-time optimal route plan and the existing route plan of the road user and to compare with a threshold value, which can be a system default value or predetermined by a system administrator. Then the real-time optimal route plan is selectively implemented; or the existing route plan is maintained according to the size of the difference. For example, in one embodiment of the present invention, if the difference value from the necessity evaluation exceeds the threshold value, thus the real-time optimal route plan is implemented; but when the difference value from the necessity evaluation is less than or simply equals to the threshold value, then the existing route plan is still maintained.

The route guidance database 350 is respectively coupled to the road section and intersection calculation module 310, the alternative routes generation module 320, the travel route segmentation module 325, the route guidance optimization module 330, and the optimal routes output module 340. The route guidance database 350 is used to store the real-time optimal route plans generated by the route guidance optimization module 330 and then transmits them to the road section and intersection calculation module 310, the alternative routes generation module 320, the travel route segmentation module 325, and/or the route guidance optimization module 330, for the purpose of next stage optimal route planning.

Refer to FIG. 3, in another embodiment, the road-users' route guidance subsystem 300 further includes a travel route segmentation module 325. For each alternative travel route of the road user, the travel route segmentation module 325 first divides at least one of the total traveling route for each road user into a plurality of segments according to the order of the traveling distance or time based on the beginning point and the destination point of each road user's trip purpose. The road-users' route guidance subsystem 300 for the road user is able to only perform the optimal driving path calculation operation for the first segment or some segments with the higher ranking, and then perform the remaining optimal travel route calculation operations in sequence, and the real-time optimal route planning for each user who provides route information is generated and sent it to each terminal device in sequence. This significantly reduces the calculation time that was originally required to process all the driving paths of the road user at one time, and meets the system function requirement of generating the optimal driving path for each road user in real time.

For example, please refer to FIG. 4, there are five feasible alternative traveling routes between the road user's current location and trip destination, including: Route A, Route B, Route C, Route D, and Route E. If the road user chooses the total travel time as the basis for determining its optimal travel route. At this condition, the route plan generation module 320 first estimates the travel time of each road segment along each alternative travel route including the driving time on the road segment and the average stopped delay time spent on the stop-and-wait red signal at the downstream intersection.

Assuming that the roughly estimated travel time of the five alternative travel routes can be obtained: t_{A}=17 min, t_{B}=16 min, t_{C}=14 min, t_{D}=15 min, t_{E}=18 min (as shown in FIG. 4). Then, in order to meet the requirement of real-time update of the optimal travel route and to achieve the purpose of streamlining computing resources, the route plan generation module 320 first sorts the roughly estimated total travel time of the above-mentioned 5 alternative travel routes from small to large, and obtain their priority order as t_{C}, t_{D}, t_{B}, t_{A}, t_{E}. If the system must meet the requirements of reduced computing power and real time updates, the number of travel routes (K) for subsequent more accurate calculations (for example, K≤3) can be limited. In this example, only three routes, t_{C}, t_{D}, and t_{B}, with relatively shorter travel times, need to be retained from the five alternative routes.

Secondly, the travel route segmentation module 325 only needs to perform further travel time calculation including driving time and stopped delay time calculation analysis on the first driving segment of the above three alternative travel routes, and then combine the result of such calculation with the previous estimated travel time of the next driving segment to find the optimal travel route for the entire journey of the road user. In certain embodiments, if the system of the present invention sets the update frequency or real-time update requirement of the optimal travel route of the road user to once every 2 minutes, and the travel route segmentation module 325 first divides the above three alternative travel routes into two time segments (such as dividing t_{C} of Route C into two time partitions or segments such as t_{C1} and T_{C2}), and then sets the first driving segment of each driving route, that is, the driving segment with an equivalent driving distance, to 2 minutes. Under this condition, the total travel time of the three shortlist alternative travel routes can be divided into: t_{C}=14 min=t_{C1} (2 min)+t_{C2} (12 min), t_{D}=15 min=t_{D1} (2 min)+t_{D2} (13 min), t_{B}=16 min=t_{B1} (2 min)+t_{B2} (14 min), etc. Furthermore, the travel route segmentation module 325 subsequently prioritizes these travel routes, namely Route C, Route D, and Route B.

For example, for the first 2-min. travel time or equivalent travel distance (i.e., t_{C1}, t_{D1}, t_{B1}) of the first driving partitions C1, D1, and B1, since the previously estimated travel time does not take into account the stop-and-wait delays caused by the traffic signals at the intersections along the travel routes, the travel route segmentation module 325 recalculates a precise time when the road user arrives at the downstream intersection of each section based on the instantaneous driving speed of each section along the travel route, and then compare this arrival time with the optimal signal timing plan currently in effect at the downstream intersection. In this way, it can be accurately calculated whether the road user will encounter a “green phase” when the road user arrives at the downstream intersection of each section on each route, that is, the road user can pass directly (i.e., no stopped delay), or whether the road user will encounter a “red phase”, that is, the road user must stop at the intersection for a period of time before passing (i.e., there will be some stopped delay). The travel route segmentation module 325 processes the first driving partitions C1, D1, and B1 (i.e., the first 2-min. travel time or equivalent travel distance) of the three alternative travel routes, namely, Route C, Route D, and Route B, through this “dynamic/time-dependent progressive computation method”. Assuming that the road user will encounter two red light phases at three intersections along Route C1, thus experiencing a stopped delay of 40 seconds and 35 seconds respectively, and a green light phase where the road user can pass directly. If the previously estimated travel time of the first 2-min travel time or equivalent travel distance is 70 seconds, the original 2-min travel time t_{C1} can be calculated by this dynamic progressive computation method to obtain a more accurate t_{C1}′ whereas t_{C1}′=70 s+40 s+35 s=145 s=2 min. 25 s. Similarly, through the same dynamic progressive computation method described above, it can be found that the road user will encounter a red light phase at two intersections along Route D1, and suffer a 25-second stopped delay, and a green light phase that allows direct passage. If the original estimated driving time is 50 seconds, the original 2-minute segment t_{D1} driving time can be calculated again by this dynamic progressive computation method to obtain a more accurate t_{D1}′ whereas t_{D1}′=50 s+25 s=75 =1 min. 15 s. Similarly, if the road user encounters a red phase at two intersections along Route B1, with a stopped delay of 45 seconds, and a green phase where the road user can pass directly. If the previously estimated travel time is 60 seconds, the original 2-minute section t_{B1} travel time can be more accurately calculated to be t_{B1}′=60 s+45 s=105 s=1 min. 45 s.

Please refer to FIG. 4, after the above dynamic progressive computation method has been performed to obtain the more accurate t_{C1}′, t_{D1}′, t_{B1}′ of the first travel segments C1, D1, B1 of the above three alternative travel routes C, D, B, the route guidance optimization module 330 then combines and adds up the previously estimated travel times of the second travel segments C2, D2, B2 of the three alternative travel routes, and the final results are: new t_{C}′=new t_{C1}′ (2 min.25 s)+t_{C2} (12 min)=14 min.25 s, new t_{D}′=new t_{D1}′ (1 min.15 s)+t_{D2} (13 min)=14 min.15 s, new t_{B}′=new t_{B1}′ (1 min.45s)+t_{B2} (14 min)=15 min.45 s. Next, the route guidance optimization module 330 also re-optimizes the total travel time of the three alternative travel routes, so as to generate the accurate optimal travel route for the road user. Thus, the optimal travel route at present time has changed from the originally estimated Route C to the recalculated Route D.

An urban traffic control subsystem 200 is coupled with the road and traffic network information subsystem 100. The urban traffic control subsystem 200 includes an intersection arrival-flows prediction module 210, an intersection grouping module 215, a timing plans generation module 220, a timing plans optimization module 230, an optimal timing plans output module 240, a traffic control database 250, and a historical route guidance database 260. The urban traffic control subsystem 200 calculates the real-time integrated traffic information of each road section to generate the real-time optimal signal timing plan for each intersection in the digital urban traffic-control road network.

Refer to FIGS. 1, 2 and 3, the urban traffic control subsystem 200 further includes an intersection grouping module 215 for grouping adjacent intersections according to the correlation nature of their approach arrival-flow patterns, wherein the intersections in the digital urban traffic-control road network 110 are divided into many signal groups including isolated intersection groups, arterial intersection groups, and network intersection groups according to the correlation nature, either high or low, of their approach arrival-flow patterns between adjacent intersections.

Refer to FIG. 3, in one embodiment; the urban traffic control subsystem 200 is responsible for generating the optimal timing plan for each intersection in the entire urban traffic control road network 110 in real time. Considering the huge scope of the entire urban traffic control road network 110, for example, covering thousands of signalized intersections, this computer operation for the server would inevitably consume excessive computing power and result in time-consuming. The intersection grouping module 215 in the urban traffic control subsystem 200 first divides or groups the entire urban traffic control network 110 into multiple intersection groups. Those intersection groups are divided into an isolated Intersection group, which includes only an isolated or independent intersection, an arterial intersection group, which includes multiple adjacent intersections on the same road, and a network intersection group, which includes multiple adjacent intersections on multiple roads by the intersection grouping module 215 according to the characteristics of the arriving traffic flow at each intersection approach. The urban traffic control subsystem 200 is able to use those intersection groups described above as signal units to generate a set of optimal signal timing plan for each intersection group in turn. In other words, the optimal signal timing plan for each intersection produced within the same group has the same signal cycle-length and separate green time splits and specific signal offsets to maintain a fixed timing plan coordination relationship among them in order to save the calculation time of the entire urban traffic control network 110 and meet the system function requirements of instantly producing the optimal signal timing plan for each intersection. Finally, the urban traffic control subsystem 200 generates the configuration of all signal groups in the entire or part of the urban traffic control network 110, i.e. taking those intersection groups as a signal unit, and multiple signal sets of optimal timing plans for each signal group are outputted in the entire digital urban traffic control road network 110. Of course, in other embodiments of the present invention, the intersection grouping module 215 may also divide the entire digital urban traffic control road network 110 into more than or less than three intersection groups according to their traffic flow characteristics, all of which are within the scope of the present invention. In other words, in order to achieve this improvement in operational performance, the present invention will, in terms of sequence, provides a new intersection grouping module to the original series of four operational modules of the urban traffic control subsystem 200 after the intersection arrival-flows prediction module 210 preform its functions and before the timing plans generation module 220 preform its functions, so as to perform the above or below related operations of grouping adjacent intersections, thereby significantly improving the operational efficiency of the entire system of the present invention.

In certain embodiments, the system of the present invention uses individual signal groups as units to generate a whole set timing plan of each intersection in the group, which can significantly reduce the computing resource consumption of the server. All adjacent intersections in the same signal group have a fixed timing plan coordination relationship among them, that is, all adjacent intersections in the same signal group will have the same signal cycle-length, and there will be a separate signal offset between adjacent intersections, and each adjacent intersection will also have its own specific green time split. For example, in the ABC arterial Intersection group, there are 5 adjacent intersections (ABC₁, ABC₂, ABC₃, ABC₄, ABC₅) in the same arterial intersection group and a certain timing plan ABC₁ of the arterial intersection group includes multiple timing parameters, such as: the common cycle of the group is 90 seconds, the specific signal offsets of the 5 intersections are (ABC₁: 0 second, ABC₂: 15 seconds, ABC₃: 25 seconds, ABC₄: 35 seconds, ABC₅: 50 seconds), and the individual green time split of the 5 intersections (ABC₁: 30%, ABC₂: 45%, ABC₃: 35% seconds, ABC₄: 55%, ABC₅: 40%). This is the ABC, entire timing plan of the arterial intersection group. (Note: the “signal offset” of each intersection refers to the difference between the time when the green light at that intersection starts to turn on and the time when the green light at the first intersection of the arterial Intersection group starts to turn on, and the green time split refers to the percentage of the green time of the entire signal cycle in each arterial intersection).

In one embodiment, the urban traffic control subsystem 200 further includes a timing plans generation module 220 for generating multiple feasible signal timing plans for each intersection of the digital urban traffic-control road network 110 according to the time-space arrival-flows matrix or pattern of each intersection and signal timing restrictions of each intersection.

In one embodiment, the urban traffic control subsystem 200 further includes a timing plans optimization module 230 for generating the real-time optimal signal timing plan by optimizing an objective function of the multiple feasible signal timing plans according to a set of pre-determined traffic control objective.

In one embodiment, the real-time optimal signal timing plan is updated according to the combinations of trip destination point and one of beginning location and subsequent instant location of each road-user. In other word, the present invention can directly obtain instant travel information (the combinations of trip destination point and one of beginning location and subsequent instant location of each road-user) from road users without any subsequent data-processing and analysis. the instant travel data of each road user that needs to be collected in the present invention is only the combinations of trip destination point and one of beginning location and subsequent instant location of each road-user, which is required to be used for subsequent analysis and calculation work, while other or additional road and travel information is not necessary.

In one embodiment, the urban traffic control subsystem 200 further comprises an intersection arrival-flows prediction module 210, and the intersection arrival-flows prediction module 210 is configured to perform the following steps: all vehicles traveling on each upstream adjacent road section of each intersection are considered based on real-time traffic information from road sections within the digital urban traffic control road network 110; the travel time required for each vehicle to reach its downstream intersection is estimated by dividing the distance between the vehicle's current location and the downstream intersection by the real-time average speed of the corresponding upstream adjacent road section; subsequently, the traffic flow arrival rate distribution of all turning movements at each approach of the intersections within the digital urban traffic control road network 110 is calculated in real-time based on an update time interval set by the intersection traffic flow prediction module 210 for generating the real-time optimal signal timing plan.

In one embodiment, the timing plans generation module 220 is further configured to perform the following steps: based on the traffic flow constraints of each intersection, dividing the turning flow rate of each phase of each intersection by the saturation flow rate of the corresponding turning movement, thereby generating the flow ratio of that turning movement; then, the largest value among all turning movements of each phase is selected as the representative flow rate of that phase in the signal cycle of each intersection; the representative flow ratios of all phases are compared with each other to form a comparison result including green time split ratio of the signal cycle of each intersection, and the actual green time of each phase in one signal cycle is allocated according to the comparison result among all green time split ratios of signal phases of each intersection.

In one embodiment, the green time split of each phase in a signal cycle of each intersection and both an upper and a lower limits of the possible signal cycle length are determined according to the traffic flow arrival rate distribution of each approach of each intersection, traffic signal restriction conditions and traffic flow restriction conditions set at each intersection; and the multiple feasible signal timing plan alternatives for each intersection described above or below are then computed between the upper and lower limits of the signal cycle length.

In one embodiment, the road-users' route guidance subsystem 300 further includes a route guidance optimization module 330 for calculating the value of a target performance index among the K shortest travel routes, one by one, based on a pre-determined route planning objective, and extracts one route plan with the optimal or best value of the target performance index as the real-time optimal route plan for each road-user from his/her current location to the predetermined destination point.

In one embodiment, the alternate routes generation module 320 is configured to generate the multiple feasible route plans within the urban traffic control network by performing the following steps: calculating, for each vehicle from its current location to its destination point, the travel time or travel distance required to first reach its downstream intersection, the total travel time or travel distance required to traverse all complete road sections along subsequent routes, and the average stopped delay time at each intersection or the travel distance within each intersection; combining these travel times or distances for all feasible route plans to form an alternative travel route group by applying several existing multiple-path network analysis methods, for example, Shortest Path Algorithms, K-Shortest Paths Algorithms, Dynamic Traffic Assignment Method, Multi-Objective Optimization Methods, Stochastic & Machine Learning Approaches, Path Similarity Analysis . . . etc.

The intersection arrival-flows prediction module 210 generates the real-time average vehicle speed of each road section, the estimated arrival time at each intersection, and/or the real-time arrival-flows allocation of each intersection by calculating the real-time integrated traffic information of each road section, and further generates a time-space arrival-flows matrix or pattern of each intersection of the digital urban traffic-control road network.

Taking an intersection in the digital urban traffic-control road network as an example, the said real-time arrival-flows allocation of each intersection and the time-space arrival-flows matrix or pattern of each intersection can be realized by the following two working tables:

TABLE 1
the estimation of real-time (e.g. within 4 seconds) arrival-flows allocation at certain intersection

| | | Real-time average | | | | |
|---|---|---|---|---|---|---|
| Upstream | Real-time average | vehicle speed of the | Distance between each | Travel time required | | |
| road sections | vehicle speed of | upstream road | approaching vehicle on | for each approaching | Real-time arrival- | Real-time turning- |
| adjacent to the | the upstream road | section(converted | the upstream road section | vehicle to reach the | flows calculation | flows allocation |
| intersection | section (km/hr) | to m/s) | and the intersection (m) | intersection (sec.) | at the intersection | at the intersection |
| Eastbound | 36 | 10.00 | 15, 35, 75, 130, 185, . . . | 1.5, 3.5, 7.5, 13, 18.5, | 2 | Left turn 1 |
| approach | | | | . . . | | Straight 1 |
| Westbound | 42 | 11.67 | 14, 30, 43, 88, 132, . . . | 1.27, 2.57, 3.68, 7.54, | 3 | Straight 2 |
| approach | | | | 11.3, . . . | | Right turn 1 |
| Southbound | 33 | 9.17 | 11, 20, 29, 36, 74, 105, | 1.2, 2.2, 3.2, 3.9, 8.1, | 4 | Left turn 1 |
| approach | | | . . . | 11.45, . . . | | Straight 2 |
| | | | | | | Right turn 1 |
| Northbound | 30 | 8.33 | 12, 23, 32, 69, 117, . . . | 1.4, 2.5, 3.9, 8.3, 14.0, | 3 | Straight 2 |
| approach | | | | . . . | | Right turn 1 |

Note:
The “average vehicle speed” and “distance” mentioned in Table 1 are the numbers assumed in examples, and “real time” is “within 4 seconds” as an example.

TABLE 2
the estimation of time-space arrival-flows matrix at certain intersection

| | | Estimation of arrival-flows in continuous | | | | |
|---|---|---|---|---|---|---|
| Upstream | Turning | calculation time interval at the intersection | | | | |
| road sections | of the | Within | Within | Within | Within | Within |
| adjacent to the | upstream | 0~4 | 4~8 | 8~12 | 12~16 | 20~24 |
| intersection | section | sec | sec | sec | sec | sec |
| Eastbound | Left turn | 1 | 0 | 0 | 1 | . . . |
| approach | Straight | 1 | 0 | 0 | 0 | . . . |
| | Right turn | 0 | 1 | 0 | 0 | . . . |
| Westbound | Left turn | 0 | 1 | 0 | 0 | . . . |
| approach | Straight | 2 | 0 | 0 | 0 | . . . |
| | Right turn | 1 | 0 | 0 | 0 | . . . |
| Southbound | Left turn | 1 | 0 | 0 | 0 | . . . |
| approach | Straight | 2 | 0 | 1 | 0 | . . . |
| | Right turn | 1 | 0 | 0 | 0 | . . . |
| Northbound | Left turn | 0 | 0 | 0 | 0 | . . . |
| approach | Straight | 2 | 0 | 1 | 0 | . . . |
| | Right turn | 1 | 0 | 0 | 0 | . . . |

Note:
“0~4 sec”, “4~8 sec”, “8~12 sec”, and “12~16 sec” in Table 2 refer to the continuous calculation interval indicated in the intersection arrival-flows prediction module 210.

The above Table 1 takes any intersection in the digital urban traffic-control road network as an example. The calculation/estimation process of the real-time arrival-flows allocation of each intersection is described as follows: travel time required for each vehicle to reach the intersection and the real-time arrival-flows at the intersection in the calculation time interval in the intersection arrival-flows prediction module 210 (4-second interval as an example) are obtained by calculating the distance between the current position of each approaching vehicle driving on all the adjacent upstream road sections and the downstream intersection, the real-time average vehicle speed of each road section. In addition, the above Table 2 adopts the calculation/estimation results of Table 1 and shows the detailed calculation/estimation process of the arrival-flows allocation in the continuous calculation interval along the time axis from all upstream approach of the intersection, so as to form the said time-space arrival-flows matrix or pattern of each intersection in the intersection arrival-flows prediction module 210. In addition, for the convenience of description, those two tables (Tables 1 and 2) only use a single intersection as an example for the calculation, and are not used to limit the scope or conditions of the present invention.

The timing plans generation module 220 is coupled with the intersection arrival-flows prediction module 210 and the intersection grouping module 215. The timing plans generation module 220 can generate multiple feasible signal timing plans for each intersection based on the said time-space arrival-flows matrix or pattern and the signal timing restrictions of each intersection. The signal timing restriction of each intersection can be a phasing type, a yellow period, an all-red period, a pedestrian green period and pedestrian flashing green period, and a minimum green period and maximum green period for each phase within a signal cycle.

The timing plans optimization module 230 is coupled with the timing plans generation module 220. The timing plans optimization module 230 firstly calculates the performance index value, based on a set of pre-determined traffic control objective function, for each of the multiple feasible signal timing plans which are developed in the timing plans generation module 220. In some embodiments, the performance index value of the pre-determined traffic control objective function can be obtained by using various mathematical programming techniques, e.g. Exhaustive Search method, Hill-Climbing method, etc. In some embodiments, the timing plans optimization module 230 uses each signal group as a unit to generate a complete set of real-time optimal timing plans for each signal group in the entire urban traffic control road network 110.

The pre-determined traffic control objective function can be a linear or non-linear form. Its traffic control objective may be minimum total delay time or minimum total travel time or minimum total number of stops or minimum queue length, or a combination thereof. In addition, the real-time optimal signal timing plan is updated at a frequency based on the input frequency of the road-users' travel information and/or the calculation frequency of the timing plans optimization module 230.

In some embodiments, the input data of the timing plans optimization module 230 is not only the input data mentioned in the above embodiments, but also includes the configuration of all signal groups or their intersection composition divided by the intersection grouping module 215 and multiple feasible group timing plans for each signal group. In addition, in this embodiment, the timing plans optimization module 230 uses the signal groups as units to generate a complete set of real-time optimal timing plans for each signal group in the entire urban traffic control road network 110.

The optimal timing plans output module 240 is coupled with the timing plans optimization module 230. The optimal timing plans output module 240 is used to transmit the real-time optimal signal timing plan of the intersection to the corresponding intersection traffic signal control facility 400 of the intersection to control the subsequent operation of the traffic signal. In other embodiments, in addition to the input data mentioned in the embodiments described above or below, the configuration of all signal groups or their intersection composition after division by the intersection grouping module 215, and a complete set of real-time optimal timing plans for each signal group in the entire urban traffic control network 110 are added. The entire set of real-time optimal timing plans for each signal group in the entire urban traffic control road network 110 is transmitted to the traffic control database 250 for storage and subsequent use; above data is also downloaded to the signal controllers at each intersection to perform timing plan updates; on the other hand, above data is also downloaded to the personal mobile device 500 or an on-board unit 500 of each road user via a wireless/satellite communication transmission network or bypass roadside units 600.

The traffic control database 250 is respectively coupled to the intersection arrival-flows prediction module 210, the intersection grouping module 215, the timing plans generation module 220, the timing plans optimization module 230, and the optimal timing plans output module 240. The traffic control database 250 is used to store the real-time integrated traffic information of all road sections generated by the road-users' travel information input module 120, as well as all real-time optimal signal timing plans generated by the timing plans optimization module 230. The traffic control database 250 then transmits them to the intersection arrival-flows prediction module 210, the timing plans generation module 220, and/or the timing plans optimization module 230.

Please refer to FIG. 3; the system of the present invention further includes a historical route guidance database 260, which continuously stores data of a single optimal travel route for each road user. That is, the historical route guidance database 260 continuously stores the historical data of the single optimal travel route uploaded by all road users and the historical route guidance database 260 is used by the urban traffic control subsystem 200 to produce a complete set of real-time optimal timing plans for each signal group of the urban traffic control road network 110 in the next stage.

An electronic traffic control map display module 700 is respectively coupled to the intersection arrival-flows prediction module 210 and the optimal timing plans output module 240. The electronic traffic control map display module 700 displays the real-time optimal signal timing plans generated by the timing plans optimization module 230, and/or real-time average vehicle speed of each road section generated by the intersection arrival-flows prediction 210.

An Intersection traffic signal control facility 400 is coupled with the optimal timing plans output module 240. For example, each intersection traffic signal control facility 400 continuously receives, updates, and stores the real-time optimal signal timing plan in real-time. Each intersection traffic signal control facility 400 then implements the received real-time optimal signal timing plan on time based on a pre-determined time-table.

Please refer to FIG. 1 and FIG. 2, FIG. 2 is a schematic diagram of data transmission communication according to an embodiment of the present invention. The traffic signal control facility 400 at the intersection in FIG. 2 may include a traffic signal controller 410 and a traffic signal 420. The mobile device 500 can perform data transmission communication through a satellite 810 in order to transmit the real-time travel information of a road user of the vehicle 10. The road user of the vehicle 10 can also connect with the wireless communication network base station 800 through the mobile device 500 and perform data transmission and communication with the urban traffic control subsystem 200.

The urban traffic control subsystem 200 can generate the real-time optimal signal timing plan for each intersection by calculating the travel information of road-users and the integrated traffic information of each road section, and transmits the real-time optimal signal timing plan to the traffic signal control facility 400 at each intersection to enable the traffic signal controller 410 to drive the traffic signal 420 into subsequent operation. The road-users' route guidance subsystem 300 can generate the real-time optimal route plan for each road-user by calculating the real-time travel information of road-users, the real-time integrated traffic information of each road section, and the real-time optimal signal timing plan of each intersection generated by the urban traffic control subsystem 200, and transmitted them to the mobile device 500 of road-users or via the roadside unit 600 for an indirect data transmission. It should be noted that the locations of the components in FIG. 2 are only examples, and are not used to limit the conditions of their erection, installation, or installation locations.

In addition, in some embodiments, the present invention is based on the premise of “real-time response”. The bidirectional interactive traffic-control management system with improved operational architecture through edge computation 1000 will immediately perform the update calculation of the multiple feasible timing plans and the generation of the real-time optimal timing plans according to the input frequency of the travel information sent by the road-users and it may be as short as a few seconds or as a few minutes. As for the actual update frequency of the optimal timing plans of the present invention, it highly depends on the computer computing speed of the urban traffic control subsystem 200 and the complexity of the control logic and it may be as short as a length of “Time Step” as a few seconds, or it may be equal to or exceed the length of a few minutes of a normal signal cycle length.

Similarly, the road-users' route guidance subsystem 300 will immediately perform an update calculation of the multiple feasible route plans and the generation of the real-time optimal route plan based on the input frequency of the travel information sent by the road-users and it may be as short as a few seconds or as long as a few minutes, and the generating frequency of the real-time optimal timing plan in the urban traffic control subsystem 200. As for the actual update frequency of the timing plans, it highly depends on the computer's computing speed of the urban traffic control subsystem 200 and the complexity of the control logic and it may be as short as a length of “Time Step” as a few seconds, or it may be equal to or exceed the length of a few minutes of a normal signal cycle length.

In one embodiment, the road-users' route guidance subsystem further includes an alternate routes generation module 320, which is configured to generate K shortest travel routes for each road user within the urban traffic control network by performing the following steps: first, searching all feasible routes from each road user's current location to predetermined a destination point by applying multiple-path network analysis methods; second, estimating total travel time of each route by adding travel time spent in each road section plus average stopped delay due to red signal time at each intersection along the route; limited number (K) of feasible travel routes for more accurate travel time computation, so as to reduce computing power and facilitate real-time update; fourth, sorting in order of total travel time for all feasible routes according to total travel time and choose K shortest travel routes. In this embodiment, when calculating the total travel time of each route, the alternate route generation module 320 simultaneously incorporates two types of time conditions, namely, travel time spent in each road section and average stopped delay due to red signal time at each intersection. Since all known navigation systems in the present time have not yet been interconnected with urban traffic control systems, they are unable to take into account the actual delay time caused by vehicles stopping and waiting at intersections. In other words, only the average stopped delay can be roughly calculated using relevant models. Before sorting the feasible paths, the alternate route generation module 320 defines a limited number (K) of feasible travel routes. Although K is only a quantitative parameter, it can be determined by the road user or by the system based on the number or total length of the user's potential feasible routes, or the computational efficiency requirement that the optimal route must be updated in real time.

In another embodiment, the road-users' route guidance subsystem further includes a travel route segmentation module 325, which is configured to generate a more accurate travel time of the first road segment of K shortest travel routes by performing a “dynamic/time-dependent progressive computation method” in the following steps: first, partitioning each travel route into two segments for all K shortest travel routes by travel time or equivalent travel distance based on the update frequency of optimal travel route or the real-time update requirement; second, predicting the arrival time when the road-user reaches each downstream intersection within the first segment of each travel route based on the instantaneous driving speed of each road section along the first segment of each travel route; third, calculating stop-and-wait delays caused by red signal time at each intersection along the first segment of each travel route by comparing predicted arrival time and an optimal signal timing currently in effect at each intersection; Since the previously estimated travel time (in alternate routes generation module 320) only uses an average stopped delays at each intersection along the travel route, therefore, next, obtaining a more accurate travel time of the first segment of each travel route by adding all driving time of each road section and all stop-and-wait delays at each intersection along the first partition of each route. The focus of the technical scheme in this embodiment is to segment all K shortest travel routes that need to be subsequently calculated for the precise travel time according to the system's immediacy requirement for updating the optimal path (referring to the update time interval), that is, partition each travel route into two segments for all K shortest travel routes by travel time or equivalent travel distance, and travel route segmentation module 325 subsequently only calculates the travel time for the first segment. Next, the “dynamic/time-dependent progressive computation method” executed by the travel route segmentation module 325 first estimates the precise time it takes for a road user to reach each downstream intersection (of the first route segment) based on his/her current vehicle speed, and then compares the timing with the optimal signal timing plan currently being executed at each intersection, thereby calculating the actual stop-and-wait delays consumed by the vehicle waiting for the red light at the intersection (or being able to go through when encountering a green light), and then the travel time of each sub-segment on the first route segment is added, so as to obtain a more accurate travel time of the first segment of each travel route.

In another embodiment, the road-users' route guidance subsystem 300 further includes a route guidance optimization module 330, which is configured to generate the optimal driving route for each road user by performing the following steps: first, recalculating a more accurate total travel time of K shortest routes by adding the more accurate travel time of the first segment of each route and the previously estimated travel time of the second segment of each travel route; second, sorting in the order of the more accurate total travel time for all K shortest travel routes; third, optimizing an objective function for K shortest travel routes according to pre-determined route planning objectives which are of the minimum total travel time, or the minimum total travel distance, and/or a route choice preference setting; forth, choosing the travel route with minimum total travel time or the best value of the objective function as the optimal travel route for each road user. In this embodiment, the route guidance optimization module 330 recalculate a more accurate total travel time of K shortest routes by adding the precise travel time of the first segment of each route and previously estimated travel time of the second segment of each travel route. Then, the route guidance optimization module 330 performs subsequent sorting procedure and comparisons.

As described above, the present invention has following advantages:
1. In order to overcome the technical problem of covering thousands of signalized intersections renders the computer operation for the server to inevitably consume excessive computing power, the intersection grouping module of the present invention divides the entire urban traffic control network into multiple intersection groups according to the characteristics of the approach arriving flow patterns between adjacent intersections.
2. For each feasible alternative travel route of the road user, the travel route segmentation module of the present invention will generate a more accurate travel time of K shortest travel routes by applying a “dynamic/time-dependent progressive computation method”, which will be able to significantly reduce the calculation time that was originally required for processing all the feasible travel routes of a single road user at the same time. 0
3. Under the systematic framework and functions of the present invention, a future urban traffic control/management center will be able to fully monitor various real-time road traffic conditions and traffic-related events (e.g. traffic congestions, traffic accidents, road constructions, adverse weather conditions . . . etc.) in the urban road network, and thus can introduce various corresponding reaction plans in advance.
4. Under the systematic framework and functions thereof of the present invention with improved operational architecture through edge computation, a future urban traffic control/management center can also transmit the information about various real-time road and traffic events in the urban road network to the road-users for their reference and usage, so that they can avoid the congested road sections where traffic accidents occurred or road construction is underway, and thus highly improve the operation efficiency of the urban road network.
5. Under the systematic framework and functions thereof of the present invention with improved operational architecture through edge computation, future urban traffic control/management center be able to collect and process the real-time travel information such as the trip origins and destinations of road-users and their driving tracks in the road network, together with the optimal signal timing plans partially generated by the plurality of terminal devices, to further develop a more accurate route guidance system for all road-users for their moving reference, so as to provide the road-users with specific feedback measures about their traffic movement information.

The above description is only illustrative, and not restrictive. Any other equivalent modifications or changes that do not depart from the spirit and scope of the present invention should be included in the scope of the claims of the present invention. As disclosed in the above description and attached drawings, the present invention can provide a bidirectional interactive traffic-control management system with improved operational architecture through edge computation. It is new and can be put into official, public, and industrial use.

### SYMBOL TABLE

100: road and traffic network information subsystem
110: digital urban traffic-control road network
120: road-users' travel information input module
200: urban traffic control subsystem
210: intersection arrival-flow prediction module
215: intersection grouping module
220: timing plans generation module
230: timing plans optimization module
240: optimal timing plans output module
250: traffic control database
260: historical route guidance database
300: road-users' route guidance subsystem
310: road section and intersection calculation module
320: alternative routes generation module
325: travel route segmentation module
330: route guidance optimization module
340: optimal routes output module
350: route guidance database
400: traffic signal control facility
410: signal controller
420: traffic signal
500: mobile device and on-board unit
600: roadside unit
700: electronic traffic control map display module
800: system of a third-party travel information service provider
1000: bidirectional interactive traffic-control management system with improved operational architecture through edge computation

### SYMBOL TABLE OF DESIGNATED REPRESENTATIVE FIGURE

100: road and traffic network information subsystem
200: urban traffic control subsystem
300: road-users' route guidance subsystem
400: traffic signal control facility
410: signal controller
420: traffic signal
500: mobile device
600: roadside unit
1000: bidirectional interactive traffic control management system with improved operational architecture through edge computation
DSRC: dedicated short range communication

What is claimed is:

1. A bidirectional interactive traffic-control management system with improved operational architecture through edge computation comprising:
a server, including:
a road and traffic network information subsystem, including a digital urban traffic-control road network and a road-users' travel information input module; and
an urban traffic control subsystem, being coupled with the road and traffic network information subsystem;
a plurality of terminal devices located respectively at a road user end or a roadway end, and are independently provided from a central server, where each terminal device is coupled with the road and traffic network information subsystem and the urban traffic control subsystem, and the plurality of terminal devices is configured to collect the road-users' real time travel information, and each terminal device includes a road-users' route guidance subsystem;
wherein the server is configured to executed following steps:
the digital urban traffic-control road network stores a vector-type road structure including a plurality of road sections and a plurality of intersections including various road geometric characteristics and traffic control attributes that are pre-stored;
the road-users' travel information input module receives the road-users' real time travel information from the plurality of terminal devices to collect real-time travel information of road-users on the plurality of road sections;
the collected road-users' travel information is overlaid with the road geometric characteristics and traffic control attributes that are pre-stored to form real-time integrated traffic information in the plurality of road sections and plurality of intersections of the digital urban traffic-control road network;
an urban traffic control subsystem generates a real-time optimal signal timing plan for each intersection according to the real-time integrated traffic information of all road sections which are linked together by intersections; and
a road-users' route guidance subsystem generates a real-time optimal route plan for each road user who has provided real time travel information to each terminal device for navigating each road user corresponding to a terminal device to the optimal subsequent travel route by calculating the real-time travel information of all road-users, the real-time integrated traffic information of each road section, and the real-time optimal signal timing plan of each intersection;
wherein the urban traffic control subsystem further includes an intersection grouping module for grouping adjacent intersections according to a correlation nature of their approach arrival flow patterns, wherein the intersections in the digital urban traffic-control road network are divided into signal groups including isolated intersection groups, arterial intersection groups, and network intersection groups according to the correlation nature of their approach arrival flow patterns, from high to low, between adjacent intersections in the urban traffic control network; wherein the urban traffic control subsystem further includes a timing plans generation module for generating multiple feasible signal timing plans for each intersection in the digital urban traffic-control road network according to the time-space arrival-flows matrix or pattern of each intersection and signal timing restrictions of each intersection;
wherein the urban traffic control subsystem further includes a timing plans optimization module for generating the real-time optimal signal timing plan by optimizing an objective function of the multiple feasible signal timing plans according to a set of pre-determined traffic control objective;
wherein the real-time optimal signal timing plan is updated according to the combinations of trip destination point and one of beginning location and subsequent instant location of each road-user.

2. The bidirectional interactive traffic-control management system with improved operational architecture through edge computation as claimed in claim 1, wherein the urban traffic control subsystem is further for generating optimal signal timing plans corresponding to each isolated intersection groups, each arterial intersection groups, and each network intersection groups; wherein the optimal signal timing plan of each intersection in the same signal group has the same signal cycle-length and separate green time split and specific signal offset, so as to maintain a fixed timing plan relationship among all the intersections in the same signal group.

3. The bidirectional interactive traffic-control management system with improved operational architecture through edge computation as claimed in claim 1, wherein if the road-users' route guidance subsystem is provided in a mobile device or an on-board unit of a road user, the real-time optimal route plan is generated for the road user to use in the mobile device or on-board unit corresponding to each road user; if the road-users' route guidance subsystem is provided in the roadside units or if a system of a third-party travel information service provider is used, then input frequencies of the road user's traveling information, operation frequencies of the timing plans optimization module and/or necessity evaluations of route update are firstly evaluated, and then the generated real-time optimal route plan is transmitted to the mobile device or the on-board unit corresponding to each road user.

4. The bidirectional interactive traffic-control management system with improved operational architecture through edge computation as claimed in claim 1, further including a system of a third party travel information provider, connected with the server and the terminal devices, for receiving the real-time traveling information of some road users collected by their mobile devices or an on-board units and transmitting it to the road and traffic network information subsystem; the system of the third party travel information provider is used for transmitting the real-time optimal route plan to a mobile device or an on-board unit corresponding to some road users.

5. The bidirectional interactive traffic-control management system with improved operational architecture through edge computation as claimed in claim 1, wherein the road-users' route guidance subsystem further includes a travel route segmentation module, be configured to perform the following steps: at least one of the total traveling route for each road user is divided into a plurality of sections according to the beginning location and the destination point of each road user's trip purpose, based on calculating results from real-time route information of all road users, real-time integrated traffic information of each road section, and real-time optimal signal timing plan for each intersection in the road and traffic network information subsystem, and an optimal traveling route calculation operation is first performed on the sections with the higher ranking, and then an optimal traveling route calculation operation for the remaining sections is performed in sequence, and the real-time optimal route planning for each user who provides route information is generated and sent it to each terminal device in sequence, so as to guide each road user corresponding to each terminal device to obtain the real-time optimal route plan.

6. The bidirectional interactive traffic-control management system with improved operational architecture through edge computation as claimed in claim 1, wherein the urban traffic control subsystem further comprises an intersection arrival-flows prediction module, be configured to perform the following steps:
all vehicles traveling on each upstream adjacent road section of each intersection are considered based on real-time traffic information from road sections within the digital urban traffic control road network; the travel time required for each vehicle to reach its downstream intersection is estimated by dividing the distance between the vehicle's current location and the downstream intersection by the real-time average speed of the corresponding upstream adjacent road section; subsequently, the traffic flow arrival rate distributions of all turning movements at each approach of the intersections within the digital urban traffic control road network are calculated in real-time based on an update time interval set by the intersection arrival-flow prediction module for the real-time optimal signal timing plan.

7. The bidirectional interactive traffic-control management system with improved operational architecture through edge computation as claimed in claim 1, wherein the urban traffic control subsystem further comprises a timing plan generation module, be configured to perform the following steps: based on the traffic flow constraints of each intersection, dividing the turning flow rate of each phase of each intersection by the saturation flow rate of the corresponding turning movement, thereby generating the flow ratio of that turning movement; then, the largest value among all turning movements of each phase is selected as the representative flow rate of that phase in the signal cycle of each intersection; then the representative flow ratios of all phases are compared with each other to form a comparison result including green time split ratio of the signal cycle of each intersection, and the actual green time of each phase in one signal cycle is allocated according to the comparison result among all green time split ratios of signal phases of each intersection.

8. The bidirectional interactive traffic-control management system with improved operational architecture through edge computation as claimed in claim 6, wherein the timing plans generation module is further used to perform following steps: the green time split of each phase in a signal cycle of each intersection and both an upper and a lower limits of the possible signal cycle length are determined according to the traffic flow arrival rate distribution of each approach of each intersection, traffic signal restriction conditions and traffic flow restriction conditions set at each intersection; and the multiple feasible signal timing plan alternatives for each intersection are then computed between the upper and lower limits of the signal cycle length.

9. The bidirectional interactive traffic-control management system with improved operational architecture through edge computation as claimed in claim 1, wherein the road-users' route guidance subsystem further includes a route guidance optimization module for calculating the value of a target performance index among the multiple feasible route plans, one by one, based on a pre-determined route planning objective, and extracts one traveling route plan with the optimal or best value of the target performance index as the real-time optimal route plan for each road-user from his/her current location to the predetermined destination point.

10. The bidirectional interactive traffic-control management system with improved operational architecture through edge computation as claimed in claim 1, wherein the alternate routes generation module is configured to generate the multiple feasible route plan within the urban traffic control network by performing the following steps: calculating, for each vehicle from its current location to its predetermined destination point, the travel time or travel distance required to first reach its downstream intersection, the total travel time or travel distance required to traverse all complete road sections along subsequent routes, and the average delay time at each signalized intersection or the travel distance within each intersection; combining these travel times or distances for all feasible route plans to form a first combination group; and applying several multiple-path network analysis methods on the first combination group.

11. The bidirectional interactive traffic-control management system with improved operational architecture through edge computation as claimed in claim 1, wherein the road-users' route guidance subsystem further includes an alternate routes generation module, which is configured to generate K shortest travel routes for each road user within the urban traffic control network by performing the following steps:
searching all feasible routes from each road user's current location to predetermine a destination point by applying multiple-path network analysis methods;
estimating total travel time of each route by adding travel time spent in each road section plus average stopped delay due to red signal time at each intersection along the route;
defining a limited number (K) of feasible travel routes for more accurate travel time computation, so as to reduce computing power and facilitate real-time update, and
sorting all feasible routes according to total travel time to choose K shortest travel routes.

12. The bidirectional interactive traffic-control management system with improved operational architecture through edge computation as claimed in claim 1, wherein the road-users' route guidance subsystem further includes a travel route segmentation module, which is configured to generate a more accurate travel time of the first road segment of K shortest travel routes by performing following steps:
partitioning each travel route into two segments for all K shortest travel routes by travel time or equivalent travel distance based on the update frequency of optimal travel route or the real-time update requirement;
predicting the arrival time when the road-user reaches each downstream intersection within one first segment of each travel route based on the instantaneous driving speed of each road section along the first segment of each travel route;
calculating stop-and-wait delays caused by red signal time at each intersection along the first segment of each travel route by comparing predicted arrival time and an optimal signal timing currently in effect at each intersection;
obtaining a more accurate travel time of the first segment of each travel route by adding all driving time of each road section and all stop-and-wait delays at each intersection along the first segment of each route.

13. The bidirectional interactive traffic-control management system with improved operational architecture through edge computation as claimed in claim 1, wherein the road-users' route guidance subsystem further includes a route guidance optimization module, be configured to generate the optimal driving route for each road user, by performing the following steps:
recalculating a more accurate total travel time of K shortest routes by adding the more accurate travel time of the first segment of each route and previously estimated travel time of the second segment of each travel route;
sorting the more accurate total travel time for all K shortest travel routes;
optimizing an objective function for K shortest travel routes according to pre-determined route planning objectives which are of the minimum total travel time, or the minimum total travel distance, and/or a route choice preference setting;
choosing the travel route with minimum total travel time or the best value of the objective function as the optimal travel route for each road user.
